(19) United States
(12) Patent Application Publication
(10) Pub. No.: US 2026/0172477 A1
(43) Pub. Date: Jun. 18, 2026

(54) IMPROVEMENTS IN AND RELATING TO PROSE

(71) Applicant: Samsung Electronics Co., Ltd., Suwon-si, Gyeonggi-do (KR)

(72) Inventors: Mehrdad SHARIAT, Staines (GB); Mahmoud WATFA, Staines (GB)

(21) Appl. No.: 18/708,109

(22) PCT Filed: Nov. 7, 2022
(86) PCT No.: PCT/KR2022/017377

§ 371 Date: May 7, 2024

(30) Foreign Application Priority Data
Nov. 8, 2021 (GB) 2115999.1

(51) Int. Cl. H04L 67/14

(52) U.S. Cl. CPC H04L 67/14

(57) ABSTRACT

The disclosure relates to a 5G or 6G communication system for supporting a higher data transmission rate. A method of establishing a ProSe relay session in a network including a remote User Equipment (UE), the method comprising: registering, by a 5G ProSe UE-to-Network Relay, with the network, as a priority service (S101); indicating, by the network, priority information (S102); provisioning, to the remote UE, a special relay service code (RSC) and/or a set of relay service codes (RSCs) for the priority service (S103); discovering, by the remote UE, the 5G ProSe UE-to-Network Relay (S104); and establishing, by the remote UE, a connection for communication with the 5G ProSe UE-to-Network Relay (S105).

### CROSS-REFERENCE TO RELATED APPLICATION(S)

This application is a U.S. National Stage application under 35 U.S.C. §371 of an International application number PCT/KR 2022/017377, filed on Nov. 7, 2022, which is based on and claims the benefit of a Great Britain application number 2115348.1, filed on Nov. 8, 2021, in the Great Britain Intellectual Property Office, the disclosure of each of which is incorporated by reference herein in its entirety.

### TECHNICAL FIELD

The present invention relates to Proximity Services (ProSe), particularly ProSe support for user equipment (UEs) in Restricted Service Areas and especially ProSe Priority Service Indication.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Proximity services (ProSe) for the 5GS is being specified TS 23.304. ProSe allows for direct discovery and communication between UEs using so called “PC5 resources” where these resources don't require other resources in the core network. ProSe also enables UEs either in coverage or out of coverage, known as Remote UEs to get service via a ProSe relay UE which is known as a UE-to-network Relay (hereafter referred to as relay UE), where the relay UE is in coverage of the network. The remote UEs will use PC5 discovery and communication to discover, establish a connection, and exchange data via the relay UE towards the network.

TS 23.501 and TS 24.501 describe the concept of service area restriction which is one type of mobility restrictions that are defined in TS 23.501. The service area restriction is a set of TAIs in which the UE cannot get normal services except for some conditions or cases that are defined in TS 23.501 and TS 24.501.

Note: the service area restriction may be defined such that the TAIs indicate where the UE can get normal service and hence all other TAIs would be considered as TAIs in which the service is restricted.

Some of the exceptions on service area restriction are as follows: while the UE is not allowed to initiate a service request procedure, an exception to this would be the case when the UE is initiating the procedure due to:
emergency services,
any reason given the UE is a high priority access UE as defined in TS 24.501
response to paging.

Note that the definition of a high priority access is as follows from TS 24.501:
“UE configured for high priority access in selected PLMN: A UE configured with one or more access identities equal to 1, 2, or 11-15 applicable in the selected PLMN as specified in subclause 4.5.2. Definition derived from 3GPP TS 22.261.”

The configuration for high priority access as defined above happens in the USIM running on top of UICC.

Hence, there is a need to improve ProSe.

### DISCLOSURE

### Technical Problem

Based on mobility restrictions, in non-allowed area of its serving PLMN, the 5G ProSe UE-to-Network Relay and/or 5G ProSe remote UE may not be allowed to perform Relay operations e.g. Relay discovery or accept the relay connection setup, except for the conditions as defined in TS 24.501 clause 5.3.5 (e.g. emergency services, high priority access).

Currently as defined in TS 23.502, if a 5G ProSe UE-to-Network Relay UE moves into a non-Allowed Area, the AMF notifies via Namf_EventExposure_Notify to each NF Consumer (e.g. SMFs of the established PDU Sessions) which has subscribed for UE reachability event. The SMF then deactivates the PDU session (e.g. in case of a hand over-HO) if it is not for emergency services.

It is not clear how the 5G ProSe UE-to-Network Relay UE can indicate to the network to maintain a PDU session in a non-allowed area of its serving PLMN for non-emergency but priority services (e.g. high priority access UE, MPS priority, MCX priority, etc.)

### Technical Solution

According to the present invention there is provided a method, as set forth in the appended claims. Also provided is a network. Other features of the invention will be apparent from the dependent claims, and the description that follows.

It is one aim of the present invention, amongst others, to provide a method and a network which at least partially obviate or mitigate at least some of the disadvantages of the prior art, whether identified herein or elsewhere.

A first aspect provides a method of establishing a ProSe relay session in a network including a remote User Equipment (UE), the method comprising:
registering, by a 5G ProSe UE-to-Network Relay, with the network, as a priority service;
indicating, by the network, priority information;
provisioning, to the remote UE, a special relay service code (RSC) and/or a set of relay service codes (RSCs) for the priority service;
discovering, by the remote UE, the 5G ProSe UE-to-Network Relay; and
establishing, by the remote UE, a connection for communication with the 5G ProSe UE-to-Network Relay.

A second aspect provides a network configured to implement a method according to the first aspect.

### Advantageous Effects

The present disclosure proposes a set of possible procedures for the 5G ProSe UE-to-Network Relay to indicate priority service support for 5G ProSe remote UE and exemptions from mobility restriction to the network when applicable. This would enable the 5G ProSe UE-to-Network Relay to establish or maintain the PDU session to 5GC for the purpose of relaying for such exempted services.

### DESCRIPTION OF DRAWINGS

For a better understanding of the invention, and to show how exemplary embodiments of the same may be brought into effect, reference will be made, by way of example only, to the accompanying diagrammatic Figures, in which:

FIG. 1 schematically depicts a method according to an exemplary embodiment; and

FIG. 2 schematically depicts a method according to an exemplary embodiment, in more detail.

FIG. 3 illustrates a block diagram of a structure of a network entity according to an embodiment.

### MODE FOR INVENTION

The first aspect provides a method of establishing a ProSe relay session in a network including a remote User Equipment (UE), the method comprising:
registering, by a 5G ProSe UE-to-Network Relay, with the network, as a priority service;
indicating, by the network, priority information;
provisioning, to the remote UE, a special relay service code (RSC) and/or a set of relay service codes (RSCs) for the priority service;
discovering, by the remote UE, the 5G ProSe UE-to-Network Relay; and
establishing, by the remote UE, a connection for communication with the 5G ProSe UE-to-Network Relay.

The second aspect provides a network configured to implement a method according to the first aspect.

Note that the proposals herein may be provided using the term UE-to-Network Relay UE, however this may refer to a Layer-2 UE-to-Network Relay UE, a Layer-3 UE-to-Network Relay UE, or both. As such, the proposals should be considered as an example but not a limitation. The proposals herein can be applied in any order and in any combination.

In one example, the method comprises and/or is a method of Priority Service Indication, for example as part of ProSe connection establishment and communication via relay.

### 5GS Registration as a Priority Service

In one example, the method comprises registering, by a 5G ProSe UE-to-Network Relay, with the network (for example, if not already registered). (For the case of L2 Relay or L3 Relay with N3IWF) 5G ProSe Remote UE when in coverage may also register to the network directly to its own serving AMF. If not in coverage, the 5G ProSe Remote UE may register to the network after the relay PDU session is established (after step 15) via 5G ProSe UE-to-Network Relay. The PLMN serving the 5G ProSe UE-to-Network Relay and the PLMN to which the 5G ProSe Remote UE registers can be the same PLMN or two different PLMNs.

### Priority Information Indication

In one example, registering, by the 5G ProSe UE-to-Network Relay, with the network comprises including, for example by the AMF, a Message Priority header to indicate priority information when communicating with any other core network node.

During the registration procedure for either 5G ProSe UE-to-Network Relay or 5G ProSe Remote UE (when applicable), when the Establishment cause is associated with priority services (e.g. MPS, MCS) or for a high priority access UE, the AMF includes a Message Priority header to indicate priority information when communicating with any other core network node e.g. an SMF or another entity. PCF in HPLMN is notified on the priority service of the 5G ProSe UE-to-Network Relay or 5G ProSe Remote UE (when applicable). Alternatively, the determination of the high priority service for the UE in question, by the AMF, may be based on any combination of the following: subscription information, RSC(s), slice (S-NSSAI), or DNN. When the AMF determines that the UE in question is, or the services associated with the UE are, high priority then based on any of the methods described above then the AMF should include a Message Priority header to another core network node, where this node may be an SMF or any other entity.

In one example, the method comprises provisioning, for example by the PCF, to the UE a special relay service code (RSC) and/or a set of relay service codes (RSCs), for example for high priority access UE or priority services. In one example, the RSC and/or the set of RSCs is associated with the priority information indicated via the AMF or alternatively independent therefrom. In one example, provisioning, to the UE the RSC and/or the set of RSCs comprises indicating whether the RSC or a particular RSC of the set of RSCs is associated with a high priority service.

### UE Policy Authorization and Provisioning With Special RSC(s)

During service authorization and provisioning for 5G ProSe UE-to-Network Relay or 5G ProSe Remote UE (when applicable), the PCF may provision to the UE special relay service code (RSC) or a set of relay service codes (RSCs) for high priority access UE or priority services. These RSCs can be associated with the priority information indicated via AMF or alternatively can be independent from it. When provisioning to the UE, the RSCs, optionally the PCF, may indicate whether an RSC is associated with a high priority service or not. The semantics of this indication may be achieved in different ways, such as but not limited to, an indication per RSC or a list of high priority RSC and/or a list of low priority RSC, etc. RSC priority information (e.g. as listed above) may come from any network node (e.g. PCF and/or AMF, etc) using any NAS message. Note that the provisioned information may not be limited to an RSC only but may be any combination of: RSC(s), slice (S-NSSAI), or DNN.

In one example, the method comprises verifying, by the UE, the priority information. In one example, the method comprises storing, by the UE, the priority information. In one example, the method comprises determining, by the UE, to use an RSC including determining, by the UE, a priority associated with the RSC.

The UE may verify the contents and optionally save (i.e. store) the priority information accordingly, where this priority information may be in the form of one or more RSC that is prioritized (or not prioritized) as described above. As such, when the UE determines to use an RSC, the UE may determine the priority associated with the RSC using the priority information that it has stored (which was in turn received, optionally from a network entity). Note that the provisioned information may not be limited to an RSC only but may be any combination of: RSC(s), slice (S-NSSAI), or DNN. Alternatively, the UE may be preconfigured with this information.

In one example, verifying, by the UE, the priority information comprises checking an integrity thereof.

When receiving any (priority information) from the network or network node, the UE may first verify if the received information passes a security check (e.g. an integrity check). If yes, then the UE may store and/or use the information as described above. Otherwise, the UE may discard the information.

In one example, the method comprises updating, to the UE, the priority information.

Note that the network node which sends this information may send an updated information to the UE at any time based on local policies and/or changes in the subscription information or based on requests from external application functions, optionally, via an exposure function. The change may be a change in the entire information or a change in the priority level associated with a particular type of information e.g. RSC. When the UE receives a new information, the UE may either add it to the existing information, delete it from the existing information, or replace the existing information with the new one. This may be done based on an operation code (e.g. add, replace, delete, etc) in the received contents, which the core network entity is, therefore, proposed to do when sending the information to the UE.

In one example, the method comprises performing, by the 5G ProSe Remote UE, discovery of the 5G ProSe UE-to-Network Relay.

### UE-to-NW Relay Discovery Procedure for Special RSCs

The 5G ProSe Remote UE performs discovery of the 5G ProSe UE-to-Network Relay. The RSC is included as part of either announcing message (Model A) or solicitation message (Model B). Only special RSCs associated with high priority access UE or priority services (or RSCs for emergency services) would be advertised or responded if 5G ProSe Remote UE and/or 5G ProSe UE-to-Network Relay are in the non-allowed area of the corresponding serving PLMN(s) or if 5G ProSe Remote UE and/or 5G ProSe UE-to-Network Relay are in any other form of restrictions (either existing or to be defined, where this restriction may be on the mobility management layer, session management layer or both, e.g. a running back-off timer may be considered to be a restriction which the UE can be exempted from per the proposals above).

### Establishment of Connection For One-To-One PC5 Communication Session and Optionally, Establishing New PDU Session(S) for Relaying Priority Services

In one example, the method comprises establishing one or more new PDU session(s) and/or modifying at least one existing PDU session.

As part of connection establishment over PC5 in this step, the 5G ProSe UE-to-Network Relay may establish new PDU session(s), or may modify at least one existing PDU session, for relaying purpose.

In one example, establishing one or more new PDU session(s) and/or modifying at least one existing PDU session comprises including, by the 5G ProSe UE-to-Network Relay, a ProSe Priority Service Indication parameter.

If the PDU session request is for special RSCs as outlined previously, 5G ProSe UE-to-Network Relay may include a newly proposed “ProSe Priority Service Indication” parameter as part of PDU session establishment request (or as part of the PDU session modification request message) to the AMF.

In one example, the method comprises setting, by the UE, a request type.

As an alternative or an additional action, the UE may set the Request Type (e.g. in the UL NAS TRANSPORT message which carries the 5GSM message) to indicate “Priority Request” if the PDU Session Establishment Request message (or the PDU Session Modification Request message) is a request to establish (or modify) a PDU Session for high priority access UE or priority services via 5G ProSe UE-to-Network Relay, where the determination of a ‘high priority’ may be based on any of the methods previously described (e.g. based on any combination of the provided parameters earlier). This is in addition to the “Emergency Request” as already defined by 3GPP in TS 23.502.

Note that the Request type may take the value:
“initial priority request” to indicate that the 5GSM message is an initial request (i.e. request to establish a new session) and it is a (high) priority request, or
“priority request” to indicate that the 5GSM message is related to an existing session and it is a (high) priority request.

Additionally and/or alternatively, a new field or IE may be sent by the UE, where this field or IE is different from the existing Request type and its values may be as proposed above for the Request type field.

Additionally and/or alternatively, when sending a 5GSM message that is related to a high priority request, the UE may omit the Request type IE i.e. send the UL NAS TRANSPORT message without the Request type IE.

Additionally and/or alternatively, the AMF may (e.g. based on local policies) determine that the request is related to a high priority access UE or priority services based on the establishment cause received in step 12 without any new indication from the 5G ProSe UE-to-Network Relay. The determination may be based on any combination of the methods proposed above e.g. based on the value of the Request type, or the value of a new IE or the lack of the Request type IE. When the AMF determines that the request is related to a high priority request, the AMF should allow the request and not apply a restriction to it (e.g. the AMF should not reject the request).

Based on any of the alternatives above, AMF may indicate priority service request to SMF as part of Nsmf_PDUSession_CreateSMContext Request or Nsmf_PDUSession_UpdateSMContext Request (e.g. via Message Priority header to indicate priority information).

If 5G ProSe Remote UE and/or 5G ProSe UE-to-Network Relay the UE moves into a non-Allowed Area (or if the UE is faced with any other restriction e.g. running BO timer and optionally send any information to the AMF to indicate exemption from this restriction), the AMF should notify the SMF via Namf_EventExposure_Notify of the established PDU Sessions (based on subscription to the UE reachability event), that the UE is only reachable for regulatory prioritized services. The SMF may then deactivate the PDU session if this PDU Session is not for high priority access UE or priority services as communicated in S15 in addition to emergency services. For high priority access UE, priority services and emergency services, the PDU session is maintained in non-allowed area enabling ProSe relying operation.

In one example, the method comprises transferring data over the established ProSe relay session.

### Data Transfer

Data transfer is carried out over the established ProSe relay session.

### Options

The following proposals are additionally made where these may be used in any combination and possibly used with the solutions provided above.

The term “UE” may refer to a Layer-2 UE-to-Network Relay UE, a Layer-3 UE-to-Network Relay UE, or both.

A UE may have RSC(s) or other parameters (e.g. S-NSSAI, DNN, etc) that are known to be associated with a priority level (e.g. as explained earlier). When the UE is faced with a restriction e.g. the UE is in a restricted service area, the UE should behave as follows (in any order or combination of proposals below):
When the UE is in idle mode (e.g. 5GMM-IDLE mode), the UE may receive a request from a remote UE to relay data or a NAS message, where the request may be in the form of establishing a new PC5 flow or link, etc. The UE should verify if one or more parameters related to the request (e.g. the RSC that is used) is determined to be of high priority (or of a priority level that exempts it from the restriction in question). If yes, then the UE (or the NAS layer in the UE) should/can initiate the necessary procedure e.g. the service request procedure, to transition to connected mode (e.g. 5GMM-CONNECTED mode). The UE may indicate in the NAS message that the request should be exempt from a restriction. For example, in the case of the Service Request message, the UE may set the Service type IE to indicate “elevated signalling”. Alternatively, a new field or IE can be defined and used for this purpose
When the UE needs to send a related 5GSM message (e.g. a PDU Session Establishment Request message or PDU Session Modification Request message, etc), the UE may include the priority level in the 5GSM message, where this priority level may be sent/indicated in any existing field or in a new field. This may be used by the SMF to determine the priority level of the session.
Note that the UE may also indicate that an encapsulated 5GSM message in the UL NAS TRANSPORT message is of high priority as previously explained.
Note that the UE may (also) include the actual parameter in question (e.g. an RSC) in a NAS message e.g. the UE may include the parameter in any NAS 5GMM message (e.g. UL NAS TRANSPORT, SERVICE REQUEST, etc) or in any NAS 5GSM message (e.g. PDU Session Establishment Request, PDU Session Modification Request, etc).
The network (where the network may refer to any node e.g. AMF, SMF, etc) may be configured with a set of parameters such that one or more parameters may be associated with a priority level e.g. the network may be configured with a set of RSCs, where each RSC may be known to be related to a certain priority level (e.g. RSC X is high priority, RSC Y is low priority, etc). Upon reception of any NAS message where a restriction may be in place, the network should verify if the associated parameter is related to a high priority request. The verification may be based on a local determination of the request being associated to a particular parameter and hence the priority level can be known based on the configuration information, or the request may contain the parameter for which the network node has the priority information. If the request is deemed to be (e.g. based on the parameter in question) related to a high priority request, then the network node should process the request and not reject it. The network node may determine to forward the request to another entity for which all the proposals above would apply. If the request is deemed to be related to a low priority, or the request is not a high priority, the network node may determine to not reject the request e.g. and not forward the request to another network node and optionally send the request back in a NAS message to the UE or reject the NAS message or indicate that the request was rejected with an appropriate (existing or new) cause value.

It should be noted that a UE in a restricted service area may refer to a UE that is not in an allowed area or a UE that is in a non-allowed area.

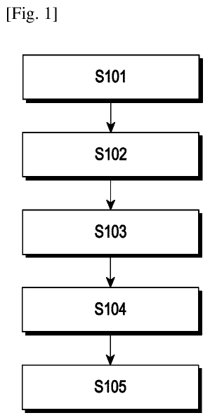

FIG. 1 schematically depicts a method according to an exemplary embodiment.

The method is of establishing a ProSe relay session in a network including a remote User Equipment (UE), the method comprising:
registering, by a 5G ProSe UE-to-Network Relay, with the network, as a priority service (S101);
indicating, by the network, priority information (S102);
provisioning, to the remote UE, a special relay service code (RSC) and/or a set of relay service codes (RSCs) for the priority service (S103);
discovering, by the remote UE, the 5G ProSe UE-to-Network Relay (S104);
establishing, by the remote UE, a connection for communication with the 5G ProSe UE-to-Network Relay (S105).

The method may include any of the steps described herein with respect to the first aspect.

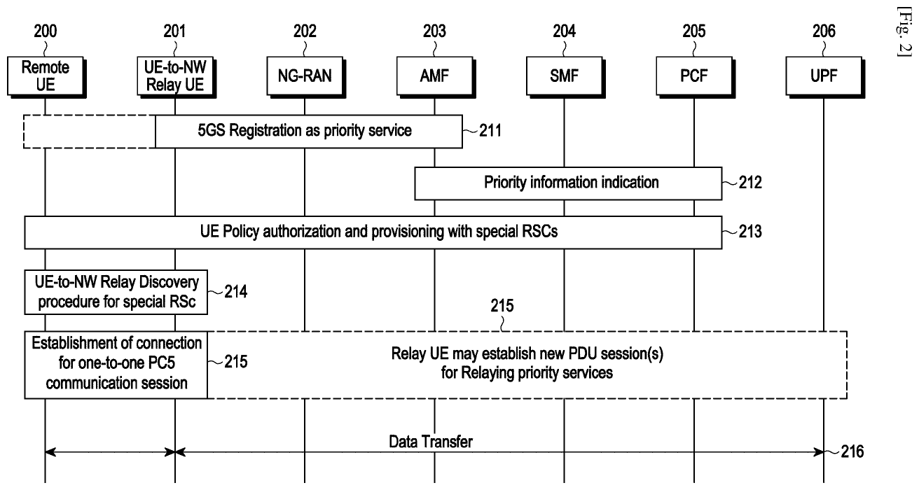

FIG. 2 schematically depicts a method according to an exemplary embodiment, in more detail. Particularly, FIG. 2 schematically depicts Priority Service Indication as part of ProSe connection establishment and communication via relay.

### Step 211—5GS Registration as a Priority Service

5G ProSe UE-to-Network Relay 201 registers to the network (if not already registered). (For the case of L2 Relay or L3 Relay with N3IWF) 5G ProSe Remote UE 200 when in coverage may also register to the network directly to its own serving AMF. If not in coverage, the 5G ProSe Remote UE 200 may register to the network after the relay PDU session is established (after step 215) via 5G ProSe UE-to-Network Relay 201. The PLMN serving the 5G ProSe UE-to-Network Relay 201 and the PLMN to which the 5G ProSe Remote UE 200 registers can be the same PLMN or two different PLMNs.

### Step 212—Priority Information Indication

During the registration procedure for either 5G ProSe UE-to-Network Relay 201 or 5G ProSe Remote UE 200 (when applicable), when the Establishment cause is associated with priority services (e.g. MPS, MCS) or for a high priority access UE, the AMF 203 includes a Message Priority header to indicate priority information when communicating with any other core network node e.g. an SMF 204 or another entity. PCF 205 in HPLMN is notified on the priority service of the 5G ProSe UE-to-Network Relay or 5G ProSe Remote UE 200 (when applicable). Alternatively, the determination of the high priority service for the UE in question, by the AMF 203, may be based on any combination of the following: subscription information, RSC(s), slice (S-NSSAI), or DNN. When the AMF 203 determines that the UE in question is, or the services associated with the UE are, high priority then based on any of the methods described above then the AMF 203 should include a Message Priority header to another core network node, where this node may be an SMF 204 or any other entity.

### Step 213—UE Policy Authorization and Provisioning With Special RSC(s)

During Service authorization and provisioning for 5G ProSe UE-to-Network Relay 201 or 5G ProSe Remote UE 200 (when applicable), the PCF 205 may provision to the UE special relay service code (RSC) or a set of relay service codes (RSCs) for high priority access UE or priority services. These RSCs can be associated with the priority information indicated via AMF 203 in Step 212 or alternatively can be independent from it When provisioning the to UE, the RSCs, optionally the PCF 205, may indicate whether an RSC is associated with a high priority service or not. The semantics of this indication may be achieved in different ways, such as but not limited to, an indication per RSC or a list of high priority RSC and/or a list of low priority RSC, etc. RSC priority information (e.g. as listed above) may come from any network node (e.g. PCF 205 and/or AMF 203, etc) using any NAS message. Note that the provisioned information may not be limited to an RSC only but may be any combination of: RSC(s), slice (S-NSSAI), or DNN.

The UE may verify the contents and save the priority information accordingly, where this priority information may be in the form of one or more RSC that is prioritized (or not prioritized) as described above. As such, when the UE determines to use an RSC, the UE may determine the priority associated with the RSC using the priority information that it has stored (which was in turn received, optionally from a network entity). Note that the provisioned information may not be limited to an RSC only but may be any combination of: RSC(s), slice (S-NSSAI), or DNN. Alternatively, the UE may be preconfigured with this information.

When receiving any (priority information) from the network or network node, the UE may first verify if the received information passes a security check (e.g. an integrity check). If yes, then the UE may store and/or use the information as described above. Otherwise, the UE may discard the information.

Note that the network node which sends this information may send an updated information to the UE at any time based on local policies and/or changes in the subscription information or based on requests from external application functions, optionally, via an exposure function. The change may be a change in the entire information or a change in the priority level associated with a particular type of information e.g. RSC. When the UE receives a new information, the UE may either add it to the existing information, delete it from the existing information, or replace the existing information with the new one. This may be done based on an operation code (e.g. add, replace, delete, etc) in the received contents, which the core network entity is, therefore, proposed to do when sending the information to the UE.

### Step 214—UE-to-NW Relay Discovery Procedure for Special RSCs

The 5G ProSe Remote UE 200 performs discovery of a 5G ProSe UE-to-Network Relay 201. The RSC is included as part of either announcing message (Model A) or solicitation message (Model B). Only special RSCs associated with high priority access UE or priority services in Step 213 (or RSCs for emergency services) would be advertised or responded if 5G ProSe Remote UE 200 and/or 5G ProSe UE-to-Network Relay 201 are in the non-allowed area of the corresponding serving PLMN(s) or if 5G ProSe Remote UE 200 and/or 5G ProSe UE-to-Network Relay 201 are in any other form of restrictions (either existing or to be defined, where this restriction may be on the mobility management layer, session management layer or both, e.g. a running back-off timer may be considered to be a restriction which the UE can be exempted from per the proposals above).

### Step 215—Establishment of Connection for One-to-One PC5 Communication Session and Optionally, Establishing New PDU Session(s) for Relaying Priority Services

As part of connection establishment over PC5 in this step, 5G ProSe UE-to-Network Relay 201 may establish new PDU session(s), or may modify at least one existing PDU session, for relaying purpose.

If the PDU session request is for special RSCs as outlined in Steps 214 and 215, 5G ProSe UE-to-Network Relay 201 may include a newly proposed “ProSe Priority Service Indication” parameter as part of PDU session establishment request (or as part of the PDU session modification request message) to the AMF 203.

As an alternative or an additional action, the UE may set the Request Type (e.g. in the UL NAS TRANSPORT message which carries the 5GSM message) to indicate “Priority Request” if the PDU Session Establishment Request message (or the PDU Session Modification Request message) is a request to establish (or modify) a PDU Session for high priority access UE or priority services via 5G ProSe UE-to-Network Relay, where the determination of a ‘high priority’ may be based on any of the methods previously described (e.g. based on any combination of the provided parameters earlier). This is in addition to the “Emergency Request” as already defined by 3GPP in TS 23.502.

Note that the Request type may take the value:
“initial priority request” to indicate that the 5GSM message is an initial request (i.e. request to establish a new session) and it is a (high) priority request, or
“priority request” to indicate that the 5GSM message is related to an existing session and it is a (high) priority request.

Alternatively a new field or IE may be sent by the UE, where this field or IE is different from the existing Request type and its values may be as proposed above for the Request type field.

Alternatively, when sending a 5GSM message that is related to a high priority request, the UE may omit the Request type IE i.e. send the UL NAS TRANSPORT message without the Request type IE.

As an alternative, AMF may (e.g. based on local policies) determine that the request is related to a high priority access UE or priority services based on the establishment cause received in 212 without any new indication from the 5G ProSe UE-to-Network Relay 201. The determination may be based on any combination of the methods proposed above e.g. based on the value of the Request type, or the value of a new IE or the lack of the Request type IE. When the AMF 203 determines that the request is related to a high priority request, the AMF 203 should allow the request and not apply a restriction to it (e.g. the AMF 203 should not reject the request).

Based on any of the alternatives above, AMF 203 will indicate priority service request to SMF 204 as part of Nsmf_PDUSession_CreateSMContext Request or Nsmf_PDUSession_UpdateSMContext Request (e.g. via Message Priority header to indicate priority information).

If 5G ProSe Remote UE 200 and/or 5G ProSe UE-to-Network Relay UE 201 moves into a non-Allowed Area (or if the UE is faced with any other restriction e.g. running BO timer and optionally send any information to the AMF 203 to indicate exemption from this restriction), the AMF 203 should notify the SMF 204 via Namf_EventExposure_Notify of the established PDU Sessions (based on subscription to the UE reachability event), that the UE is only reachable for regulatory prioritized services. The SMF 204 may then deactivate the PDU session if this PDU Session is not for high priority access UE or priority services as communicated in 215 in addition to emergency services. For high priority access UE, priority services and emergency services, the PDU session is maintained in non-allowed area enabling ProSe relying operation.

### Step 216—Data Transfer

Data transfer is carried out over the established ProSe relay session.

### Options

The following proposals are additionally made where these may be used in any combination and possibly used with the solutions provided above.

The term “UE” may refer to a Layer-2 UE-to-Network Relay UE, a Layer-3 UE-to-Network Relay UE, or both.

A UE may have RSC(s) or other parameters (e.g. S-NSSAI, DNN, etc) that are known to be associated with a priority level (e.g. as explained earlier). When the UE is faced with a restriction e.g. the UE is in a restricted service area, the UE should behave as follows (in any order or combination of proposals below):
When the UE is in idle mode (e.g. 5GMM-IDLE mode), the UE may receive a request from a remote UE to relay data or a NAS message, where the request may be in the form of establishing a new PC5 flow or link, etc. The UE should verify if one or more parameters related to the request (e.g. the RSC that is used) is determined to be of high priority (or of a priority level that exempts it from the restriction in question). If yes, then the UE (or the NAS layer in the UE) should/can initiate the necessary procedure e.g. the service request procedure, to transition to connected mode (e.g. 5GMM-CONNECTED mode). The UE may indicate in the NAS message that the request should be exempt from a restriction. For example, in the case of the Service Request message, the UE may set the Service type IE to indicate “elevated signalling”. Alternatively, a new field or IE can be defined and used for this purpose
When the UE needs to send a related 5GSM message (e.g. a PDU Session Establishment Request message or PDU Session Modification Request message, etc), the UE may include the priority level in the 5GSM message, where this priority level may be sent/indicated in any existing field or in a new field. This may be used by the SMF to determine the priority level of the session.

Note that the UE may also indicate that an encapsulated 5GSM message in the UL NAS TRANSPORT message is of high priority as previously explained.
Note that the UE may (also) include the actual parameter in question (e.g. an RSC) in a NAS message e.g. the UE may include the parameter in any NAS 5GMM message (e.g. UL NAS TRANSPORT, SERVICE REQUEST, etc) or in any NAS 5GSM message (e.g. PDU Session Establishment Request, PDU Session Modification Request, etc).
The network (where the network may refer to any node e.g. AMF, SMF, etc) may be configured with a set of parameters such that one or more parameters may be associated with a priority level e.g. the network may be configured with a set of RSCs, where each RSC may be known to be related to a certain priority level (e.g. RSC X is high priority, RSC Y is low priority, etc). Upon reception of any NAS message where a restriction may be in place, the network should verify if the associated parameter is related to a high priority request. The verification may be based on a local determination of the request being associated to a particular parameter and hence the priority level can be known based on the configuration information, or the request may contain the parameter for which the network node has the priority information. If the request is deemed to be (e.g. based on the parameter in question) related to a high priority request, then the network node should process the request and not reject it. The network node may determine to forward the request to another entity for which all the proposals above would apply. If the request is deemed to be related to a low priority, or the request is not a high priority, the network node may determine to not reject the request e.g. and not forward the request to another network node and optionally send the request back in a NAS message to the UE or reject the NAS message or indicate that the request was rejected with an appropriate (existing or new) cause value.

It should be noted that a UE in a restricted service area may refer to a UE that is not in an allowed area or a UE that is in a non-allowed area.

### Alternatives

Although a preferred embodiment has been shown and described, it will be appreciated by those skilled in the art that various changes and modifications might be made without departing from the scope of the invention, as defined in the appended claims and as described above.

Although presented in terms of ProSe and 5GS, the skilled person will readily appreciate that other network topologies and/or protocols which rely on group communication between UEs will benefit from embodiments of the invention.

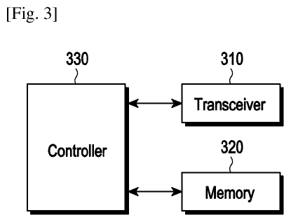

FIG. 3 illustrates a block diagram of a structure of a network device according to an embodiment.

The remote UE 200, UE-to-NW Relay UE 201, NG-RAN 202, AMF 203, SMF 204, PCF 205, UPF 206 described above in connection with FIGS. 1 to 2 may correspond to the network device of FIG. 3, respectively.

Referring to FIG. 3, the network device may include a transceiver 310, a memory 320, and a controller 330. The transceiver 310, controller 330, and memory 320 of the network device may operate according to the above-described communication methods by the network device 1. However, the components of the network device are not limited thereto. For example, the network device may include more or fewer components than the above-described components. The transceiver 310, the controller 330, and the memory 320 may be implemented in the form of a single chip. The controller 330 may include one or more processors.

The transceiver 310 collectively refers to a transmitter and a receiver of the network device and may transmit and receive signals to/from a base station, network entity, server, or another terminal. The signals transmitted and received to/from the base station, network entity, server, or the other terminal may include control information and data. To that end, the transceiver 310 may include a radio frequency (RF) transmitter for frequency-up converting and amplifying signals transmitted and an RF receiver for low-noise amplifying signals received and frequency-down converting the frequency of the received signals. However, this is merely an example of the transceiver 310, and the components of the transceiver 310 are not limited to the RF transmitter and the RF receiver.

The transceiver 310 may receive signals via a radio channel, output the signals to the controller 330, and transmit signals output from the controller 330 via a radio channel.

The memory 320 may store programs and data necessary for the operation of the network device. The memory 320 may store control information or data that is included in the signal obtained by the network device. The memory 320 may include a storage medium, such as ROM, RAM, hard disk, CD-ROM, and DVD, or a combination of storage media. Rather than being separately provided, the memory 320 may be embedded in the controller 330.

The controller 330 may control a series of processes for the network device to be able to operate according to the above-described embodiments.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of establishing a ProSe relay session by a remote user equipment (UE) in a wireless communication system, the method comprising:
obtaining at least one relay service code (RSC) for a priority service during authorization and provisioning for the remote UE;
determining a priority associated with the at least one RSC using stored information;
performing a discovery of a 5G ProSe UE-to-network relay for the priority service; and
establishing a connection with the 5G ProSe UE-to-network relay based on the discovery of the 5G ProSe UE-to-network relay.

2. The method of claim 1,
wherein the at least one RSC for the priority service is included as part of an announcing message in case that the discovery of the 5G ProSe UE-to-network relay is a Model A.

3. The method of claim 1,
wherein the at least one RSC for the priority service is included as part of a solicitation message in case that the discovery of the 5G ProSe UE-to-network relay is a Model B.

4. The method of claim 1, wherein a service indication for the priority service is included as part of a PDU session establishment request message transmitted by the 5G ProSe UE-to-network relay, or
wherein the service indication for the priority service is included as part of a PDU session modification request message transmitted by the 5G ProSe UE-to-network relay.

5. A method of establishing a ProSe relay session by a 5G ProSe UE-to-network relay in a wireless communication system, the method comprising:
obtaining at least one relay service code (RSC) for a priority service during authorization and provisioning for the 5G ProSe UE-to-network relay;
determining a priority associated with the at least one RSC using stored information; and
establishing a connection with a remote user equipment (UE) based on a discovery procedure performed by the remote UE.

6. The method of claim 5,
wherein the at least one RSC for the priority service is included as part of an announcing message in case that the discovery procedure performed by the remote UE is a Model A.

7. The method of claim 5,
wherein the at least one RSC for the priority service is included as part of a solicitation message in case that the discovery procedure performed by the remote UE is a Model B.

8. The method of claim 5, further comprising:
transmitting a PDU session establishment request message including a service indication for the priority service; or
transmitting a PDU session modification request message including the service indication for the priority service.

9. A remote user equipment (UE) for establishing a ProSe relay session in
a wireless communication system, the remote UE comprising:
a transceiver; and
a controller coupled with the transceiver and configured to control to:
obtain at least one relay service code (RSC) for a priority service during authorization and provisioning for the remote UE,
determine a priority associated with the at least one RSC using stored information,
perform a discovery of a 5G ProSe UE-to-network relay for the priority service, and
establish a connection with the 5G ProSe UE-to-network relay based on the discovery of the 5G ProSe UE-to-network relay.

10. The remote UE of claim 9,
wherein the at least one RSC for the priority service is included as part of an announcing message in case that the discovery of the 5G ProSe UE-to-network relay is a Model A.

11. The remote UE of claim 9,
wherein the at least one RSC for the priority service is included as part of a solicitation message in case that the discovery of the 5G ProSe UE-to-network relay is a Model B.

12. The remote UE of claim 9, wherein a service indication for the priority service is included as part of a PDU session establishment request message transmitted by the 5G ProSe UE-to-network relay, or
wherein the service indication for the priority service is included as part of a PDU session modification request message transmitted by the 5G ProSe UE-to-network relay.

13. A 5G ProSe UE-to-network relay for establishing a ProSe relay session in a wireless communication system, the 5G ProSe UE-to-network relay comprising:
a transceiver; and
a controller coupled with the transceiver and configured to control to:
obtain at least one relay service code (RSC) for a priority service during authorization and provisioning for the 5G ProSe UE-to-network relay,
determine a priority associated with the at least one RSC using stored information, and
establish a connection with a remote user equipment (UE) based on a discovery procedure performed by the remote UE.

14. The 5G ProSe UE-to-network relay of claim 13, wherein the controller is configured to control to:
transmit a PDU session establishment request message including a service indication for the priority service

15. The 5G ProSe UE-to-network relay of claim 13, wherein the controller is configured to control to:
transmit a PDU session modification request message including the service indication for the priority service.
